(19) United States
(12) Patent Application Publication
(10) Pub. No.: US 2018/0021690 A1
(43) Pub. Date: Jan. 25, 2018

(54) WASTE SYSTEM UTILIZING WASTE HEAT TO REDUCE WATER CONTENT IN WASTE

(71) Applicant: Stultman, LLC, Dallas, TX (US)

(72) Inventor: David Stultz, Odessa, TX (US)

(73) Assignee: Stultman, LLC, Dallas, TX (US)

(21) Appl. No.: 15/656,720

(22) Filed: Jul. 21, 2017

Related U.S. Application Data
(60) Provisional application No. 62/365,343, filed on Jul. 21, 2016.
(60) Provisional application No. 62/444,299, filed on Jan. 9, 2017.

(51) Int. Cl. B01D 1/00; B01D 5/00; B01D 1/18; C02F 1/12; C02F 1/16

(52) U.S. Cl. CPC B01D 1/0058; C02F 1/12; C02F 1/16; B01D 1/18; B01D 5/006; C02F 2303/10; C02F 2301/063

(57) ABSTRACT

According to an embodiment of the disclosure, a system reduces or eliminates the volume of waste or sewage by taking thermal energy from a waste heat source and applying it to waste or sewage. In particular configurations, the waste or sewage is homogenized and condensed prior to being sprayed across the waste heat. In particular configurations, the waste heat may be sprayed once a threshold amount of energy is contained in the waste heat.

### RELATED APPLICATIONS

This application is related to U.S. Provisional Application Nos. 62/365,343 (filed on Jul. 21, 2016) and 62/444,299 (filed on Jan. 9, 2017) both of which are incorporated by reference herein for all purposes. The present application hereby claims priority under 35 U.S.C. § 119(e) to U.S. Provisional Application Nos. 62/365,343 and 62/444,299.

### TECHNICAL FIELD

This disclosure is generally directed to waste systems. More specifically, this disclosure is directed to a waste system utilizing waste heat to reduce water content in waste.

### BACKGROUND

In a variety of settings, a common scenario involves sewage removal trucks picking up sewage and removing it from the premises of a work site. Such sewage removal can be costly. When sewage removal is being done across multiple work sites, the cost problem is compounded.

### BRIEF DESCRIPTION OF THE DRAWINGS

For a more complete understanding of this disclosure and its features, reference is now made to the following description, taken in conjunction with the accompanying drawings, in which:

FIG. 1 illustrates with block components high level features according to an embodiment of the disclosure; and

FIG. 2 illustrate components, according to an embodiment of the disclosure.

### SUMMARY OF THE DISCLOSURE

According to an embodiment of the disclosure, a system reduces or eliminates the volume of waste or sewage by taking thermal energy from a waste heat source and applying it to waste or sewage. In particular configurations, the waste or sewage is homogenized and condensed prior to being sprayed across the waste heat. In particular configurations, the waste heat may be sprayed once a threshold amount of energy is contained in the waste heat.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C. Definitions for certain words and phrases are provided throughout this patent document, those of ordinary skill in the art should understand that in many if not most instances, such definitions apply to prior, as well as future uses of such defined words and phrases.

### DETAILED DESCRIPTION

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

It will be understood that well known processes have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

A phenomena known as “waste heat” occurs in the same settings where sewage is picked up by sewage removal trucks. Simply put, an engine, turbine, or other heat generating device will have a central purpose of, for example, generating electricity or compressing a fluid. In this process, thermal energy or “waste heat” is dissipated to the environment.

Certain embodiments of the disclosure utilize waste heat to greatly reduce the amount of sewage on a site, saving on costly sewage truck removal.

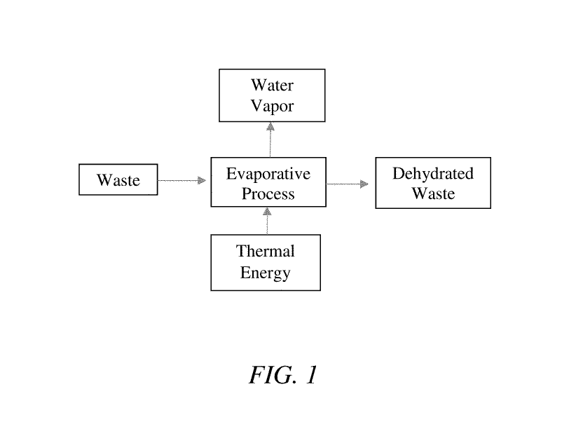

FIG. 1 illustrates with block components high level features according to an embodiment of the disclosure. Thermal energy, which may be waste heat, is used to evaporate the water in the sewage or waste. At a high level, two items are being provided to an evaporative process: thermal energy and waste. From this evaporative process, two products are yielded: water vapor and dehydrated waste.

The thermal energy is provided from some heat source. In particular configurations, such thermal energy may be waste heat that would otherwise be dissipated to the environment. As non-limiting examples, the thermal energy may be waste heat from turbines, diesel engines, or other devices that are designed for other purposes such as, for example, generating electricity or the like.

While a “waste heat” source is described in some embodiments, in other embodiments, all or a portion of the thermal energy may not be waste heat, but rather a purposefully generated heat source specifically for the evaporative process.

The waste may be processed in a variety of manners prior being subjected to the evaporative process. For example, the waste may be mixed or chopped up through pre-processing stages. Additionally, in particular configurations, different wastes may be separated or combined according to the particular processing desired. As a non-limiting example, certain waste may produce dehydrated waste that may operate as a fuel source. As another non-limiting example, certain waste may incinerate better than other waste.

The waste itself, may be human waste, or other waste as well.

The evaporative process may utilize any of a variety of techniques to enhance vaporization. As a first example, the waste may be sprayed across the heat source. Such spraying enhances the surface area of the thermal energy contact with the waste. As a second non-limiting example, the evaporative process may take placed in a sealed reduced pressure environment to reduce the latent heat of vaporization of the water. As will be recognized by one of ordinary skill in the art, a reduced pressure environment reduces the boiling point of water. And, in sub-ambient environments, water can boil at very low temperatures. For example, at 2 psi, water can boil at 126 deg F. Thus, the water may be allowed to evaporate with less thermal energy (less BTU)—provided the pressure at which such evaporation is occurring can be reduced to less than ambient pressure. However, there may be an energy cost to reduce the pressure of the waste. In particular configurations, a system may consider the energy requirements needed as tradeoff to reduce pressure. In some configurations, the energy from the dehydrated waste may be used a fuel source to decrease the pressure of the waste.

The water vapor may be dissipated to the environment. In other configurations, the water vapor may be conserved for other uses, for example, after condensing, as the water is now pure. In configurations where vaporization occurs at reduced pressure configurations, condensing may occur at reduced pressures as well.

The dehydrated waste may have a variety of uses. In some configurations, the waste may be used as energy to power a device such as, but no limited to the device creating the thermal energy or a device or system used in decreasing the pressure of the waste, or another device unrelated to the process of FIG. 1. In some configurations, all or a portion of the waste may be incinerated by the thermal energy. In yet other configurations, the dehydrated waste may serve other purposes such as a fertilizer.

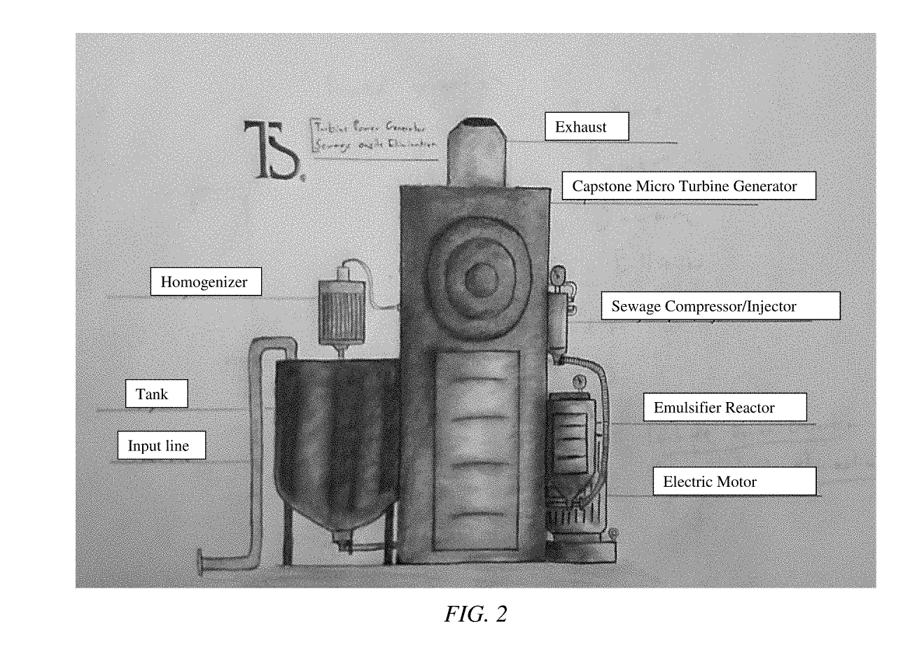

FIG. 2 illustrate components, according to an embodiment of the disclosure. The components of FIG. 2 generally operate in the manner described with reference to FIG. 1. The heat source in this particular configuration is a capstone micro turbine generator that may be designed to generate electricity. Although such a heat source is shown, yet other heat sources may be used in systems that avail from the teachings of this disclosure.

An input line provides raw sewage to a tank where a homogenizer homogenizes the sewage. The homogenized sewage is then passed on to an emulsifier reactor that grinds particles in the sewage down. In particular configurations, the emulsifier grinds particles down to 100 microns. In other configurations, the emulsifier reactor grinds particles down to different sizes. The emulsifier reactor may be powered by an electric motor that receives energy from the heat source, which is the capstone micro turbine generator.

After the emulsifier reactor, the emulsified sewage is passed through a sewage compressor/injector that injects of sprays the emulsified sewage into the heat source exhaust of the capstone micro turbine generator. The heat source exhaust of the capstone micro turbine generator evaporates the water, yielding only water vapor out of the exhaust. While a micro turbine generator is shown in this configurations, other components may be utilized, for example, as shown with reference to Appendix A. In particular configurations, some or all of the waste may also be incinerated. In particular configurations, one or more sensors may be utilized to determine when the waste heat has reach a certain minimum energy threshold level.

Any remaining waste is in a condensed dehydrated form. In certain configuration and depending on the input waste, the condensed dehydrated waste may be used for fuel for the heat source or for other uses.

Appendix A to U.S. Provisional Application No. 62/444,299 (which is incorporated by reference herein) is engineering schematics according to another embodiment of the disclosure. The differing of the components with reference to FIG. 2 is intended to illustrate that embodiments may take on different configurations. Although particular components will be referenced therein, it should expressly understood that different components may be used to other embodiment of the disclosure. Additionally, while particular sized components are provided in Appendix A, different capacity components can be provided according to different embodiments.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
a pre-processing unit configured to make the waste more uniform;
a source of thermal energy; and
an evaporative processing unit, the evaporative processing unit configured to receive an output of the pre-processing unit and the source of thermal energy to yield dehydrated waste and evaporated water.

2. The system of claim 1, wherein at least a portion of the source of thermal energy is waste heat.

3. The system of claim 1, wherein the evaporative processing unit is reduced to a subambient pressure.

4. The system of claim 1, wherein at least a portion of the dehydrated waste provides an energy source to at least partially power a unit to reduce the evaporative processing unit to a subambient pressure.

5. The system of claim 1, wherein the waste is sprayed into the evaporative processing unit.

6. The system of claim 1, wherein at least a portion of the dehydrated waste provides an energy source to at least partially power a unit to spray the waste into the evaporative processing unit.

7. The system of claim 1, further comprising:
a condensing unit that condenses evaporated water.

8. The system of claim 6, wherein the condensed evaporative water is potable.

9. The system of claim 1, wherein at least a portion of the dehydrated waste is returned to supply at least a portion of the source of thermal energy.
